(19) United States
(12) Patent Application Publication
(10) Pub. No.: US 2012/0275891 A1
(43) Pub. Date: Nov. 1, 2012

(54) WHEELCHAIR LIFT DEVICE

(76) Inventors: MCKAY PACE, Idaho Falls, ID (US); BRIAN LAIRD, Roy, UT (US); JAMES SOMERS, North Logan, UT (US)

(21) Appl. No.: 13/457,251

(22) Filed: Apr. 26, 2012

Related U.S. Application Data
(60) Provisional application No. 61/479,931, filed on Apr. 28, 2011.

(51) Int. Cl. B60P 1/44

(52) U.S. Cl. 414/549; 414/812

(57) ABSTRACT

An easy to use and compact wheelchair lift device that can be quickly and easily installed to load a wheelchair into the trunk of a vehicle. A representative lift is designed such that the wheelchair may be loaded properly and completely without the lift or the wheelchair striking the vehicle. The representative lift is also designed to reduce back strain on an operator by precluding the need to lift the wheelchair. In one embodiment, the wheelchair lift comprises a base frame that may be installed in the trunk of an automobile, a wheelchair platform configured to hold a wheelchair, a sliding frame configured to slide the wheelchair platform to or from the trunk of a vehicle, and a pivoting lift mechanism configured to raise or lower the wheelchair platform to or from the ground.

### RELATED APPLICATIONS

This patent application claims the benefit of U.S. Provisional Application 61/479,931, filed Apr. 28, 2011 and entitled WHEELCHAIR LIFT DEVICE, which is incorporated herein by reference in its entirety.

### TECHNICAL FIELD

The present disclosure relates to an apparatus for lifting a wheelchair, and in particular, a device for loading a wheelchair into an automobile.

### BACKGROUND

Approximately 1.6 million people in the United States have a disability or medical condition that requires them to use a manual wheelchair for mobility. This group includes both the elderly, who have been temporarily injured and are in a long term recovery process, and young active individuals who have been temporarily injured in an accident or sporting activity. These individuals use manual wheelchairs as a temporary means of transportation, rather than expensive electric chairs, while awaiting a full recovery. Existing wheelchair loading systems are expensive, difficult to handle, and require significant cost and time to install. Most of these systems are based on hoist technology.

### SUMMARY

Applicants have identified the need for an easy to use and compact device that can be quickly and easily installed to load a wheelchair, which may weigh between twenty-five (25) and sixty (60) pounds, into the trunk of a vehicle. The present disclosure in aspects and embodiments addresses these various needs and problems.

Wheelchair lift devices of the present disclosure may be used to smoothly, and with minimum effort, load and unload a wheelchair from the trunk of a vehicle. In one embodiment, the lift uses a pivoting lift mechanism paired with a sliding frame to tilt and slide the wheelchair into and out of the trunk of a car. A base frame may be secured to the inside of a vehicle trunk without having to modify the trunk and may also be coupled to the sliding frame. The sliding frame may be equipped with sliders on each side that allow at least a part of the sliding frame to be extended out of the trunk behind the vehicle. The portion of the sliding frame extending outside the trunk may have a pivoting shaft that allows a platform segment holding the wheelchair to be lowered to and lifted from the ground.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is an isometric view of a wheelchair lift device in a stowed position;

FIG. 2 is an isometric view of the wheelchair lift device of FIG. 1 in an extended position;

FIG. 3 is an isometric view of the wheelchair lift device of FIG. 1 in an lowered position;

FIG. 4 is an isometric view of a representative base frame of the wheelchair lift device of FIG. 1;

FIG. 5 is a close-up, isometric view of the back end of the wheelchair lift device of FIG. 1;

FIG. 6 is an isometric view of a representative wheel block assembly of the wheelchair lift device of FIG. 1;

FIG. 7 is an isometric view of another representative wheel block assembly of the wheelchair lift device of FIG. 1;

FIG. 8 is a close-up, isometric, back-end view of the back portion of the wheelchair lift device of FIG. 1;

FIG. 9 is an isometric view of a representative pivoting lift mechanism, pivoting shaft, and other components of the wheelchair lift device of FIG. 1;

FIG. 10 is an isometric view of a representative pivoting lift mechanism of the wheelchair lift device of FIG. 1;

FIG. 11 is an isometric view of a representative platform and other elements of the wheelchair lift device of FIG. 1.

FIG. 12 is an isometric view of the platform of FIG. 11, a representative brake handle, and other elements of the wheelchair lift device of FIG. 1.

FIG. 13 is an isometric view of a representative pin assembly on the wheel block assembly of FIG. 6.

FIG. 14 is an isometric view of a representative pin assembly on the wheel block assembly of FIG. 7.

### DETAILED DESCRIPTION

The present disclosure covers apparatuses and associated methods for lifting a wheelchair, and in particular, a device for loading and unloading a wheelchair into and out of an automobile. The following description provides numerous, specific details for a thorough understanding of specific preferred embodiments. However, those skilled in the art will recognize that embodiments can be practiced without one or more of the specific details, or with other methods, components, materials, etc. Furthermore, the various features of preferred embodiments described herein may be combined together to form additional embodiments. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional” or “optionally” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure describes a device for loading and unloading a manual wheelchair into and out of the trunk of a vehicle. The system may be used by an individual, or caregiver, or the wheelchair user. The system is designed to aid a caregiver in the process of loading and unloading a wheelchair from a vehicle without having to personally lift or otherwise exert appreciable energy.

The process of loading and unloading a wheelchair with the lift may prevent damage to the car, the wheelchair, or the operator. A representative lift is designed such that the wheelchair may be loaded properly and completely without the lift or the wheelchair striking the vehicle. The representative lift is also designed to reduce back strain on an operator by precluding the need to lift the wheelchair. A completely manual embodiment of the wheelchair lift is human powered. The manual lift may require less effort to lift a wheelchair than that required for an individual to lift a wheelchair absent the lift. Through the use of a pivoting mechanism, the force exerted to lift a wheel chair using the disclosed device is greatly reduced compared to the force required to directly lift and place a manual wheelchair in the trunk of a vehicle.

A manual embodiment of the wheelchair lift system may operate independent of an external power supply, battery, or other equipment that may be required to operate an automatic lift. A manual wheelchair lift may cost less to produce and install because there may be no need to provide motors or connect power to the car's electrical system. A manual lift may have fewer parts which may increase reliability. A manual lift may also provide greater control over the motion of the entire system at all times. For example, if a problem should arise during operation of the system, such as an object, or even a person in the path of movement, an individual operating the wheelchair lift can immediately stop and wait until it is safe to continue. The installation process may be simplified and safety and reliability may be improved in the absence of a powered motor.

Alternatively, an automatic wheelchair lift may be easier to operate or require less repetitive motion, such as the turning of a crank, by the operator. An automatic lift may be integrated with various functions of the car, such as opening and closing of a trunk lid. An automatic lift may also provide a more repeatable operation, ensuring that process steps in the loading and unloading process occur in the proper sequence.

The wheelchair lift device may be constructed using metal and alloy beam, rod, pipe, or bar materials. T-slotted aluminum extrusions, composite beams, and other materials known to one skilled in the art may also be used. Nuts, bolts, screws, tri-corner connectors, brackets, welding or any type of appropriate fastening system may be used to join individual pieces.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

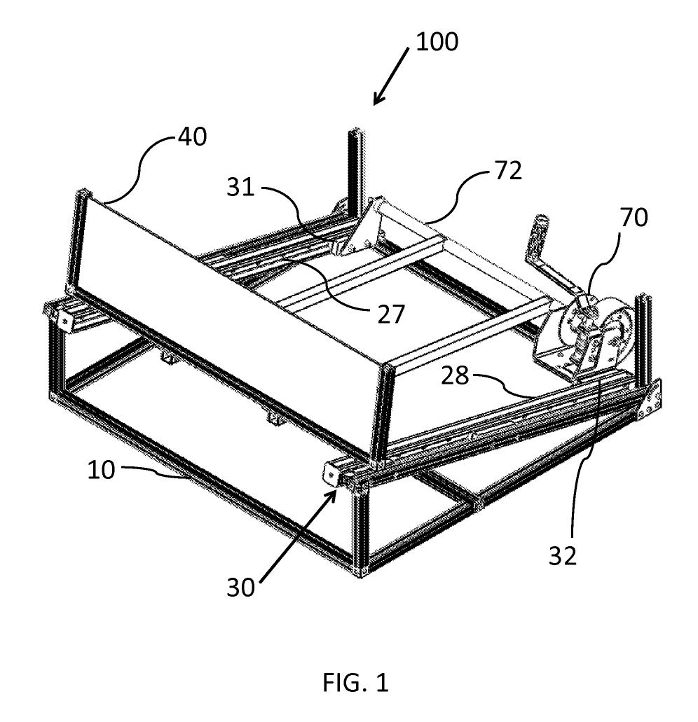

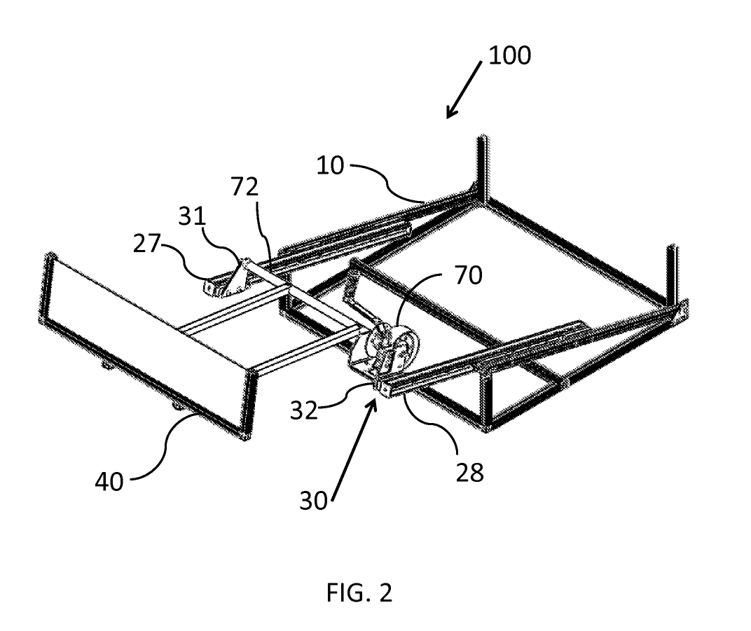

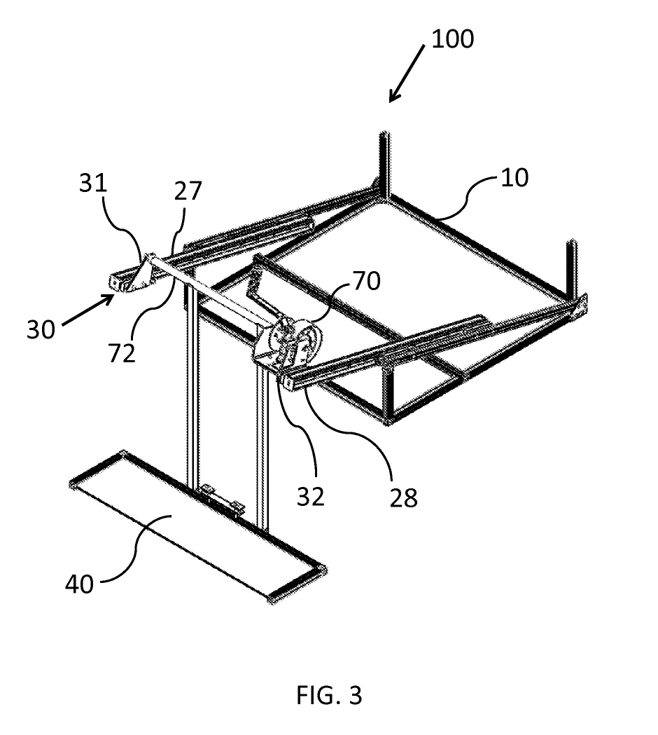

FIG. 1 illustrates an isometric view of a representative wheelchair lift in a stowed position; the stowed lift is configured to fit in the trunk of a vehicle. FIG. 2 illustrates an isometric view of the wheelchair lift of FIG. 1 in an extended position; the portion of the lift configured to hold the wheelchair (wheelchair platform 40) is extended beyond the trunk of a vehicle (not shown). FIG. 3 illustrates an isometric view of the wheelchair lift of FIG. 1 in a lowered position; wheelchair platform 40 is resting on or near ground level behind the vehicle's trunk (not shown). Referring to FIGS. 1-3, in some embodiments, a wheelchair lift device 100 comprises a base frame 10, a sliding frame 30, a platform 40, and a pivoting lift mechanism 70. Base frame 10 may be secured to the inside of a vehicle trunk (not shown). Two sides of base frame 10 may attach to sliding frame 30. Sliding frame 30 comprises left rail 27, right rail 28, and wheel block assemblies 31 and 32. Left rail 27 and right rail 28 attached to wheel block assemblies 31 and 32, respectively, and are configured to extend platform 40 beyond the length of base frame 10 and preferably, beyond the trunk of a vehicle. Platform 40 may be extended beyond the trunk of the vehicle such that when platform 40 transitions to a lowered position (FIG. 3), platform 40 does not strike the back bumper of the vehicle. The portion of platform 40 extending outside the trunk may have a pivoting shaft 72 connecting it to lift mechanism 70. Platform 40, which may be configured to hold a wheelchair (not shown), may be pivoted to lower one end of platform 40 to the ground.

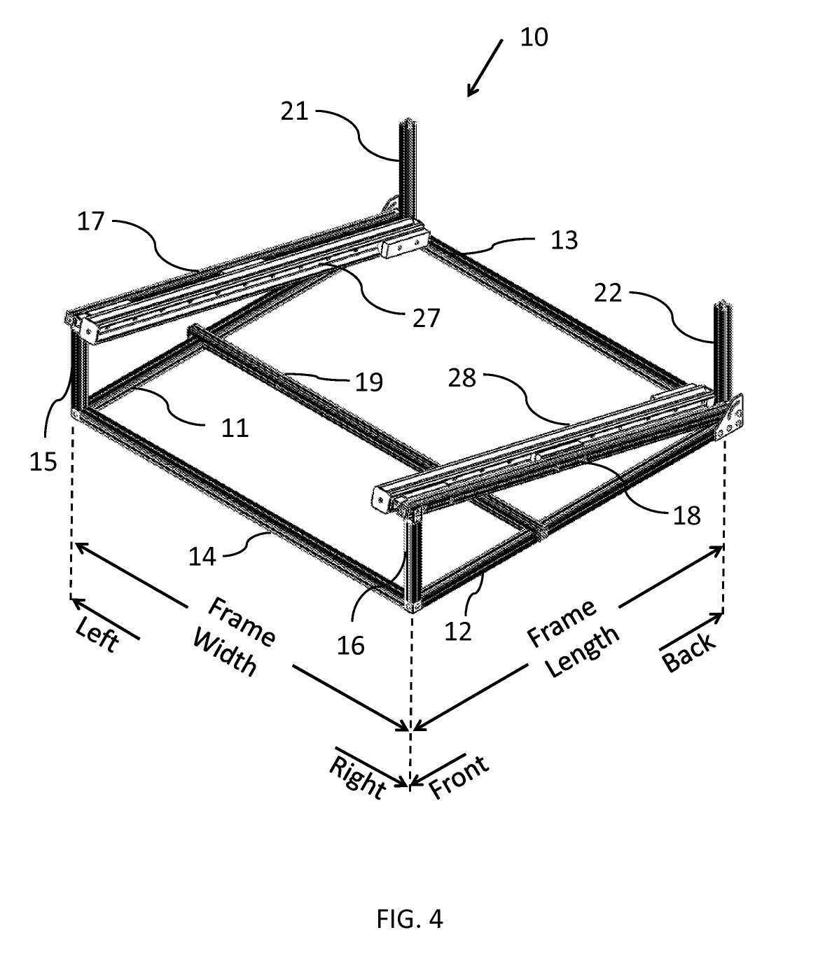

Referring to FIG. 4, a representative base frame 10 is constructed by fastening left base 11, right base 12, back base 13, and front base 14 pieces together to form a rectangular or square base that will fit into the trunk of the vehicle. Base frame 10 may be formed into other shapes, for example, a circle or the shape of the floor perimeter of a trunk of a particular vehicle. Base frame 10 may further comprise vertical bars 15, 16, 21, and 22, as well as incline bars 17 and 18. Front left vertical bar 15 is fastened to the front left corner of the base and front right vertical bar 16 is fastened to the front right corner of the base such that vertical bars 15 and 16 are essentially vertical and the front left vertical bar 15 is parallel to the front right vertical bar 16. Left incline bar 17 is fastened between the top of the left vertical bar 15 and the back left corner of the base. Right incline bar 18 is fastened between the top of the right vertical bar 16 and the back right corner of the base. Left rail 27 and a right rail 28 are fastened parallel to the left incline bar 17 and right incline bar 18, respectively.

In this embodiment, a stabilization bar 19 is fastened between the left base 11 and the right base 12 such that it is parallel to the back base 13, and front base 14. The stabilization bar 19 may be positioned at any location along the length of the left base 11 and the right base 12. A back left vertical bar 21 is fastened near the back left corner of base frame 10 and a back right vertical bar 22 is fastened near the back right corner of base frame 10 such that they are essentially vertical and the back left vertical bar 21 is parallel to the back right vertical bar 22. One end of vertical bars 21 and 22 rests on the top surface of the back base 13 and the back left vertical bar 21 is adjacent to the left incline bar 17 and the back right vertical bar 22 is adjacent to the right incline bar 18. Four vertical bars 15, 16, 21, and 22, which are part of the frame, are parallel to each other and perpendicular to the base 11, 12, 13, and 14 of the frame.

Base frame 10 may be secured to the trunk of a car through various means. In one embodiment, stabilization bar 19 may be equipped with fasteners for securing it to the bottom of the vehicle trunk. Alternatively, stabilization bar 19 may be fastened to the spare tire mount, rather than the bottom of the vehicle trunk. The attachment location of stabilization bar 19 to bars 11 and 12 may also be adjustable to account for differences in the location of a spare tire mount or another preferred attachment point on the bottom of a car trunk. For additional stability, vertical bars 21 and 22 may be telescoping bars that press fit or are otherwise attached to the ceiling of a trunk and may be adjustable for different trunk depths or to permit easier installation.

Referring back to FIG. 4, left base 11, right base 12, back base 13, and front base 14 are configured to be secured to the floor of a trunk (as described above). The heights of vertical bars 15 and 16 are such that the ends of rails 27 and 28, when extended, are able to extend beyond the length of the frame, or even beyond the bumper of a vehicle, and not strike or rub against the weather strip that seals the trunk lid to the trunk base.

In other embodiments, vertical bars 15 and 16 and incline bars 17 and 18 may not be necessary. For example, in some Sport Utility Vehicles (SUVs), the floor of the trunk or the rear storage area is flush with, or above, the weather strip that seals a back door to the frame of the SUV. In this application, rails 27 and 28 may attach directly to and extend parallel from left base 11 and right base 12, respectively.

In other embodiments, one or more members of base frame 10 may be eliminated to reduce the number of components or materials and reduce cost. For example, referring back to FIG. 4, front base 14 may be eliminated without seriously compromising the structural integrity of base frame 10, especially if stabilizer bar 19 is included. Alternatively, back base 13 may be eliminated.

In FIG. 4, left rail 27 and right rail 28 are configured to slide along incline bars 17 and 18 into an extended position (as shown in FIG. 2). Any suitable design may be used to attach rails 27 and 28 to incline bars 17 and 18. In one embodiment, rails 27 and 28 are formed from C-channel configured to receive wheels (not shown) fixed to incline bars 17 and 18. Alternatively, rails 27 and 28 may be ball-bearing drawer slides, similar to those used to open and close drawers in a cabinet.

The lift is configured such that a front portion of rails 27 and 28 extend out beyond the length of base frame 10 and preferably beyond the back bumper of a vehicle. In one embodiment, the front ends of rails 27 and 28 are configured to extend as much as forty-eight (48) inches beyond the length of base frame 10. Preferably, the front ends of rails 27 and 28 are configured to extend from zero (0) to six (6), or from six (6) to twelve (12), or from twelve (12) to twenty-four (24), or from twenty-four (24) to thirty-six (36) inches beyond the length of base frame 10. Alternatively, the front ends of rails 27 and 28 are configured to extend eighteen (18) to thirty (30) inches beyond the length of base frame 10.

The entire system is designed for flexibility such that it may be configured to fit into a variety of automobile trunks. Base frame 10 may be sized and configured to fit in various automobiles. For example, the frame length and frame width may be adjusted to fit in a specific car model or may be constructed of telescoping bar material such that the frame length and width may be adjusted for a specific size automobile trunk. In addition, vertical bars 15 and 16 may be attached with a pivot connection to the bottom of base frame 10 and adjustably connected to incline bars 17 and 18 to allow incline bars 17 and 18 to lie closer to the bottom of base frame 10 for a more compact, stowed configuration. This type of configuration may be desirable for more shallow trunks or if a more compact, stowed configuration is necessary to latch a trunk door closed.

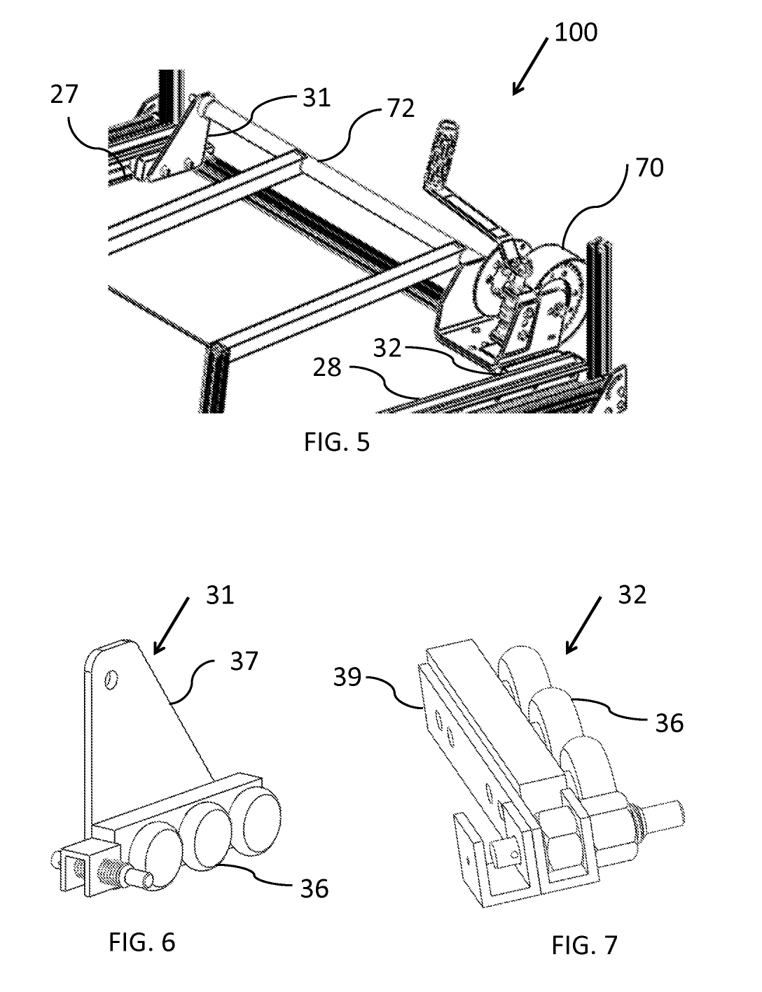

FIG. 5 illustrates a close-up, isometric view of the back-end of wheelchair lift 100 showing the connection of wheel block assemblies 31 and 32 to left rail 27 and right rail 28, respectively. Right rail 28 and lift mechanism 70 obscure most of the view of wheel block assembly 32 in FIG. 5.

FIGS. 6 and 7 illustrate isometric views of wheel block assemblies 31 and 32, respectively. In this embodiment, wheel block assembly 31 comprises wheels 36 and a rod support bracket 37, which supports pivoting shaft 72 (shown in FIG. 5) and is mounted to rail 27. Similarly, wheel block assembly 32 comprises wheels 36 and is mounted on rail 28. Wheel block assembly 32 is also connected to gear mounting bracket 72. In this embodiment, gear mounting bracket 72 forms part of mechanism 70 (shown in FIG. 5 and described in more detail below).

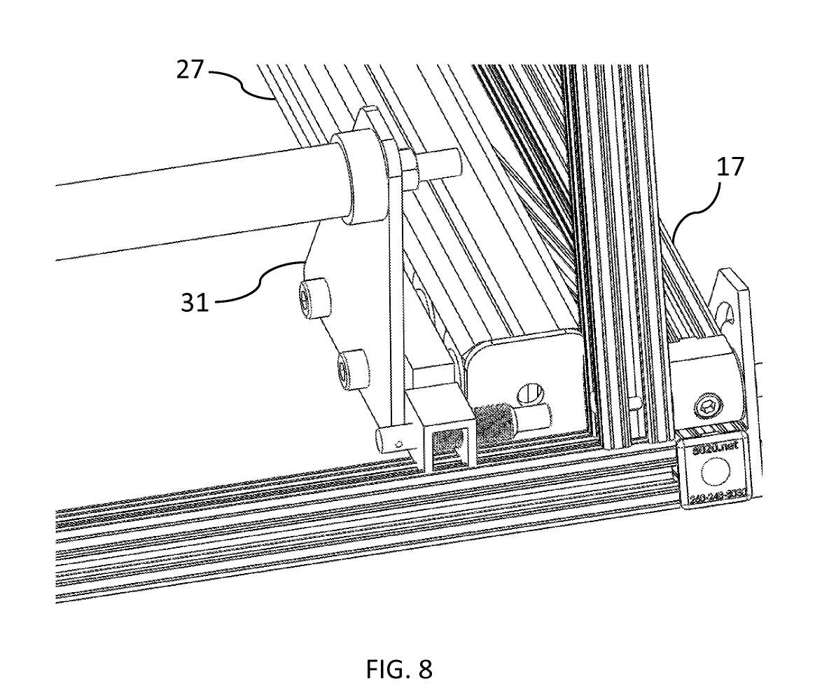

FIG. 8 illustrates a representative connection between wheel block assembly 31 and rail 27. In this embodiment, rails 27 and 28 are formed of double C-channel. One C-channel faces an incline bar (as described above); the other C-channel faces a wheel block assembly and is configured to receive wheels 36. Wheel block assembly 32 is similarly connected to rail 28. Wheel block assemblies 31 and 32 are free to slide along some portion of the length of rails 27 and 28, respectively. In one embodiment, wheel block assemblies are free to slide along at least half the length of the rails. In another embodiment, wheel block assemblies 31 and 32 are configured to slide substantially the entire length of rails 27 and 28. In a preferred embodiment, wheel block assemblies 31 and 32 are configured to slide along a sufficient length of rails 27 and 28 such that platform 40 is able to extend beyond the trunk of a vehicle (as shown in FIG. 2).

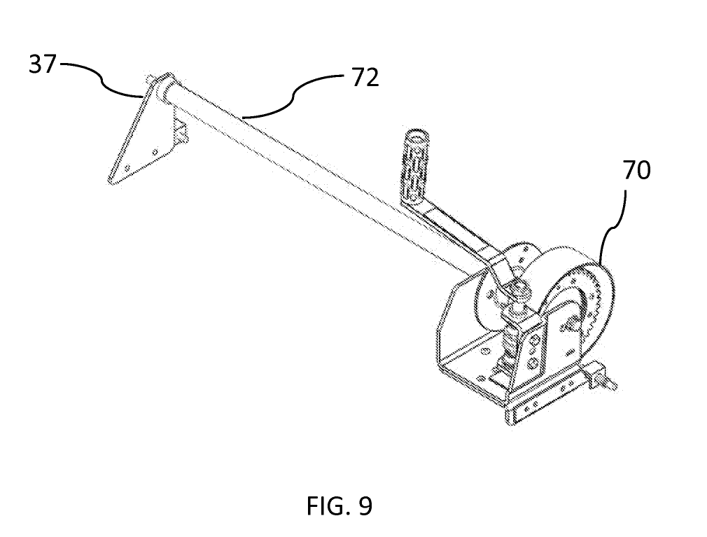

FIG. 9 illustrates an isometric view of pivoting shaft 72, support bracket 37, and lift mechanism 70. One end of the pivoting shaft 72 is positioned within pivoting shaft support bracket 37 such that pivoting shaft 72 is free to rotate. This may be accomplished by a pin extending from pivoting shaft 72 through a hole in bracket 37, an insert on bracket 37 for receiving the rod, or any other suitable structure capable of pivoting. The other end of the pivoting shaft 72 is fastened to lift mechanism 70.

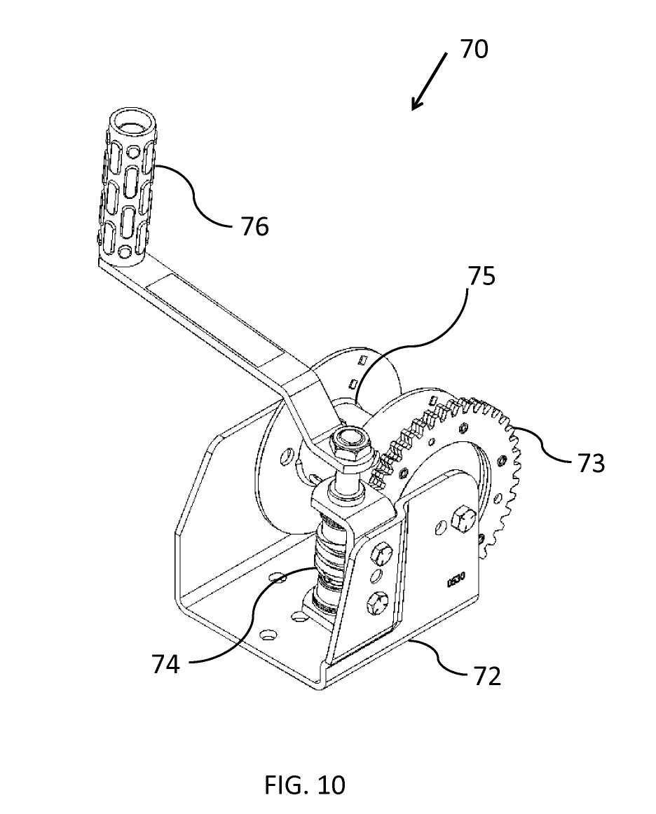

FIG. 10 illustrates an isometric view of a representative lift mechanism 70. In this embodiment, lift mechanism 70 comprises gear mounting bracket 72, worm gear 73, worm 74, drum 75, and handle 76. Drum 75 is configured to join worm gear 73 to pivoting shaft 72. Worm 74 rotates on a shaft connected to handle 76 and turns worm gear 73. Lift mechanism 70 may be configured to provide mechanical benefits in lifting a heavy load (i.e., a wheelchair) through a gear reducer and may be further configured to prevent the pivoting shaft from rotating unwantedly when the handle is released. Other embodiments of lift mechanism 70 may use a ratchet system (not shown) rather than a handle 76. In yet another embodiment, lift mechanism 70 may be comprise of a step motor that may be configured to automatically position pivoting shaft 72 in the appropriate orientation for stowing, extending, or lowering platform 40.

Indicators or rotational stops (not shown) are placed on lift mechanism 70 to stop the rotation of pivoting shaft 72 at predetermined spots (i.e., with platform 40 in an extended or lowered position). The indicators may be configured such that the user can easily determine when to stop rotating the handle for the ideal position of platform 40 to transition from an extended position to a stowed position inside the trunk of a car.

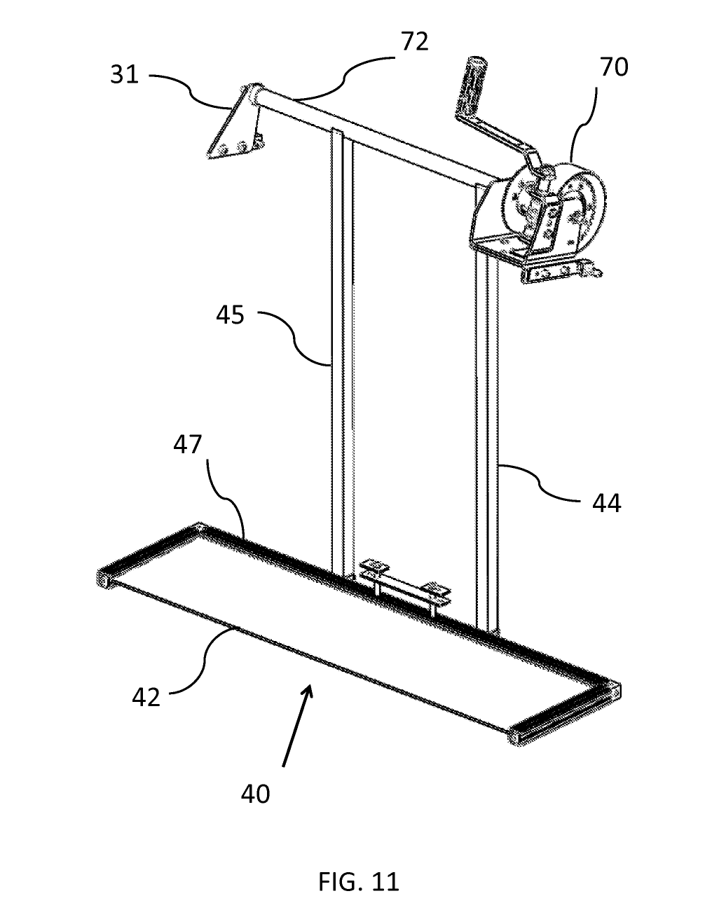

FIG. 11 illustrates the lift mechanism 70 of FIG. 9 and a representative platform 40. Platform 40 comprises platform 42 and bar swing members 44 and 45, to which the wheelchair is attached when loading and unloading it from the automobile trunk. Bar swing members 44 and 45 are fixed to pivoting shaft 72. The other end of bar swing members 44 and 45 are fixed to platform frame 47. Within frame 47 is platform 42, on which the wheelchair is placed when loading it into the vehicle. In an alternative embodiment, frame 47 may include additional members configured to receive and secure the wheels of a wheelchair without the need for platform 42.

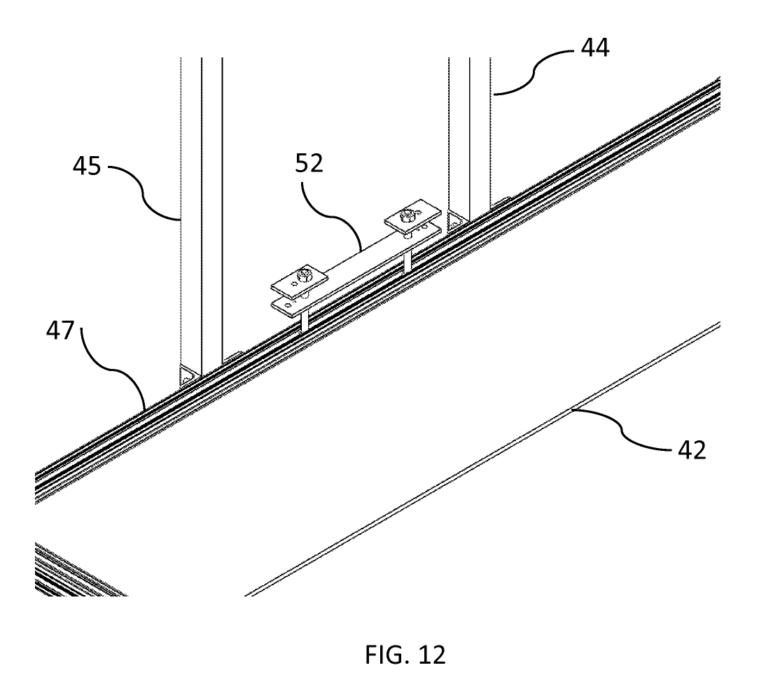

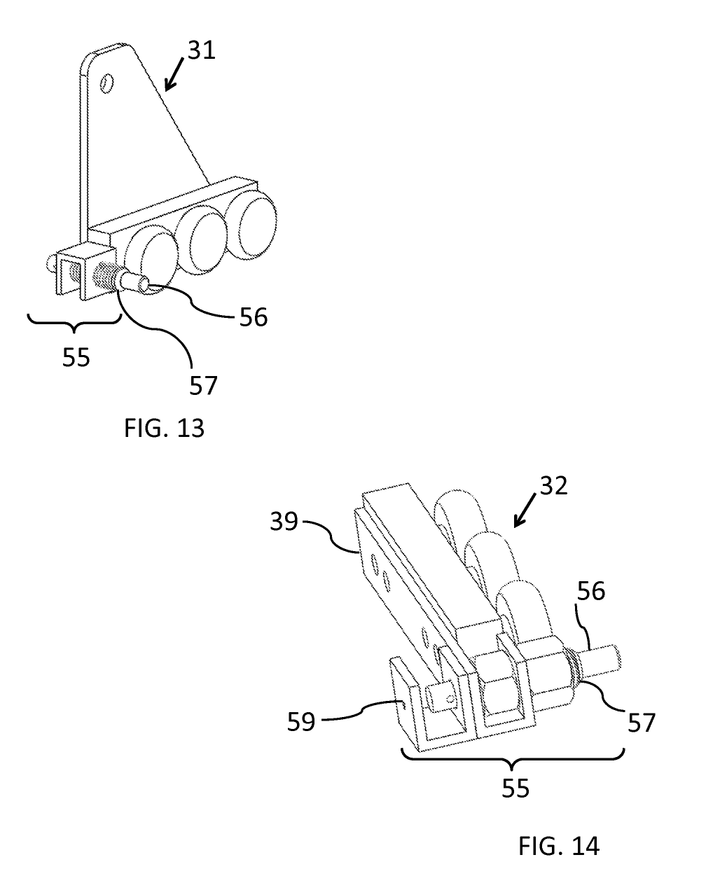

FIGS. 12, 13, and 14 illustrate a representative brake system comprising brake handle 52 (shown in FIG. 12) and pin assemblies 55 (shown in FIGS. 13 and 14). In one embodiment, brake handle 52 is mounted on platform frame 47 and spring-mounted pins 56 are mounted on wheel block assemblies 31 and 32. The brake system is configured to prevent wheel block assemblies 31 and 32 from sliding along rails 27 and 28 when platform 40 is intended to be stationary. Brake handle 52 is mounted to platform frame 47 such that brake handle 52 can be easily engaged or disengaged while extending or retracting platform 40. Cables (not shown) connect brake handle 52 to spring-loaded pins 56 in pin assembly 55.

With reference to the embodiments illustrated in FIGS. 13 and 14, cables (not shown) from brake handle 52 (shown in FIG. 12) pass through guide-holes 59 (not labeled in FIG. 13) and are connected to spring-loaded pins 56. When tension is released from brake handle 52 (shown in FIG. 12), springs 57 bias spring-loaded pins 56 into receiving holes or automatic stops (not shown) in rails 27 and 28, thus stopping the sliding motion of the sliding frame and locking the sliding frame into a desired location for raising or lowering platform 40. If spring-loaded pins 56 are disengaged (brake handle 52 is compressed), frame 40 may roll freely on rails 27 and 28 to or from a stowed position inside the trunk to an extended position outside the trunk.

The disclosed wheelchair lift is easy to use. The operation of the wheelchair lift device may be demonstrated by sequentially viewing FIGS. 1, 2, and 3. FIG. 1 shows the wheelchair lift device as it would be stowed in the trunk of an automobile. The automobile is not shown. The device is secured in place such that it does not inhibit opening and closing the trunk.

Starting from a stowed position (FIG. 1), to load a wheelchair, an operator compresses brake handle 52 (shown in FIG. 12) to release spring-loaded pins 56 (shown in FIGS. 13 and 14) or the locks, holding wheel block assemblies 31 and 32 in place. The operator then pulls (or slides) platform 40 along rails 27 and 28 out of the automobile trunk to an extended position (as shown in FIG. 2). The operator then releases brake handle 52 to set spring-loaded pins 56, thus fixing the extended position of the sliding frame and platform 40. The operator then turns handle 76 (shown in FIG. 10) to rotate pivoting shaft 72, which pivots platform 40 to ground level (as shown in FIG. 3).

With platform frame 47 extended and platform 40 on or near the ground, the operator collapses the wheelchair and rolls it onto platform 40. The operator may secure the wheelchair to swing members 44 or 45 using straps, bungee cords, rope, or any other appropriate tie system. The operator then turns handle 76 to rotate pivoting shaft 72 and platform 40. This raises platform 40 to a position such that swing members 44 and 45 are in a position to slide back into the trunk of the vehicle (as shown in FIG. 2). The operator may then release locking pins 56 and the platform containing the wheelchair may be manually pushed and moved via wheel block assemblies 31 and 32 into the trunk of the vehicle.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

What is claimed is:

1. A wheelchair lift device comprising:
a base frame, the frame having a width and a length and configured to be secured inside a trunk of a vehicle;
a sliding frame attached to the base frame and configured to extend from the base frame; and
a pivoting lift mechanism attached to the sliding frame, the pivoting lift mechanism comprising:
a pivoting shaft;
a support bracket configured to support a pivoting motion of the pivoting shaft;
a gear mounting bracket configured to support a rotating motion of a worm gear and a rotating motion of a worm, wherein the rotating motion of the worm is coupled to the rotating motion of the worm gear and the worm gear is mechanically coupled to the pivoting shaft;
extension bars attached to and extending from the pivoting shaft; and
a platform attached to the extension bars and configured to support a wheelchair.

2. The wheelchair lift device of claim 1, wherein the wheelchair lift device is configured to lift the wheelchair from a ground elevation into the trunk of the vehicle.

3. The wheelchair lift device of claim 1, wherein the length is configured to be adjustable.

4. The wheelchair lift device of claim 1, wherein the width is configured to be adjustable.

5. The wheelchair lift device of claim 1, wherein the base frame further comprises:
a left base frame member;
a right base frame member; and
a back base frame member connected to a back end of the left base member and a back end of the right base member.

6. The wheelchair lift device of claim 5, further comprising a front base member connected to a front end of the left base member and a front end of the right base member.

7. The wheelchair lift device of claim 5, further comprising one or more vertical bars attached to the back base frame member and configured to extend to a ceiling of the trunk.

8. The wheelchair lift device of claim 5, wherein the base frame further comprises a stabilization bar connected between the left base member and the right base member, the stabilization bar configured to attach to a spare tire mount.

9. The wheelchair lift device of claim 5, further comprising:
a left vertical bar attached to and extending from a front end of the left base member;
a right vertical bar attached to and extending from a front end of the right base member;
a left incline bar connected between the back end of the left base member and a top end of the left vertical bar; and
a right incline bar connected between the back end of the right base member and a top end of the right vertical bar.

10. The wheelchair lift device of claim 9, wherein the sliding frame further comprises:
a left sliding rail attached parallel to the left incline bar;
a left wheel block assembly attached to the left sliding rail;
a right sliding rail attached parallel to the right incline bar;
a right wheel block assembly attached to the right sliding rail; and
wherein the left wheel block assembly is configured to slide along some portion of the left sliding rail and the right wheel block assembly is configured to slide along some portion of the right sliding rail.

11. The wheelchair lift device of claim 10, wherein the left wheel block assembly and the right wheel block assembly are configured to slide a sufficient length of the left sliding rail and the right sliding rail, respectively, such that the platform is able to extend beyond the trunk of the vehicle.

12. The wheelchair lift device of claim 10, wherein the left wheel block assembly and the right wheel block assembly are configured to slide beyond the length of the base frame.

13. The wheelchair lift device of claim 10, wherein the left sliding rail and the right sliding rail each comprise a double C-channel.

14. The wheelchair lift device of claim 10, wherein the left sliding rail and the right sliding rail are ball-bearing drawer slides.

15. The wheelchair lift device of claim 1, wherein the pivoting lift mechanism further comprises a motor attached to the worm gear, the motor configured to provide a motive force to lift the platform about the pivoting shaft.

16. A method for operating a wheelchair lift device, the method comprising:
sliding a wheelchair platform from a stowed position to an extended position;
pivoting the wheelchair platform from the extended position to a lowered position;
loading a wheelchair onto the wheelchair platform;
pivoting the wheelchair platform from the lowered position to the extended position; and
sliding the wheelchair platform from the extended position to the stowed position.

17. The method of claim 16, further comprising:
releasing a spring loaded lock prior to sliding the wheelchair platform from the stowed position to the extended position;
engaging the spring loaded lock after sliding the wheelchair platform from the stowed position to the extended position and before pivoting the wheelchair platform from the extended position to the lowered position;
releasing the spring loaded lock after pivoting the wheelchair platform from the lowered position to the extended position and before sliding the wheelchair platform from the extended position to the stowed position; and
engaging the spring loaded lock after sliding the wheelchair platform from the extended position to the stowed position.

18. The method of claim 16, further comprising:
securing the wheelchair onto the wheelchair platform after loading the wheelchair onto the wheelchair platform and before pivoting the wheelchair platform from the lowered position to the extended position.

19. A method of for operating a wheelchair lift device, the method comprising:
sliding a wheelchair platform from a stowed position to an extended position;
pivoting the wheelchair platform from the extended position to a lowered position;
removing a wheelchair from the wheelchair platform;
pivoting the wheelchair platform from the lowered position to the extended position; and
sliding the wheelchair platform from the extended position to the stowed position.
